(19) United States
(12) Patent Application Publication
(10) Pub. No.: US 2018/0324903 A1
(43) Pub. Date: Nov. 8, 2018

(54) Method of Rapidly Melting Metal for 3D Metal Printers by Electromagnetic Induction

(71) Applicants: Richard Zeng, Guangzhou (CN); Dongguan Sai Wei Lai Te Electronic Technology Co. Ltd., Guangzhou (CN)

(72) Inventors: Richard Zeng, Guangzhou (CN); Guang Xing Zeng, Guangzhou (CN)

(21) Appl. No.: 15/587,400

(22) Filed: May 5, 2017

(51) Int. Cl. H05B 6/10; B33Y 10/00; B33Y 30/00; B33Y 40/00; B33Y 50/02; H05B 6/06; H05B 6/34; H05B 6/42; H05B 6/36

(52) U.S. Cl. CPC H05B 6/101; B33Y 10/00; B33Y 30/00; B33Y 40/00; H05B 6/367; H05B 6/067; H05B 6/34; H05B 6/42; B33Y 50/02

(57) ABSTRACT

This invention relates to the field of 3D metal printing, and more particularly to a method of rapidly melting metal for 3D metal printers by electromagnetic induction. This is a new cost-effective 3D metal printing method that enables direct heating and rapid melting of metals, higher energy conversion efficiency, higher deposition rates, smaller oxide, higher safety and controllability, faster printing, and larger-size metal components manufacturing.

### CROSS-REFERENCE TO RELATED APPLICATIONS

Not Applicable.

### FIELD OF THE INVENTION

The present invention relates to the field of 3D metal printing, and more particularly to a method of rapidly melting metal for 3D metal printers by electromagnetic induction.

### BACKGROUND OF THE INVENTION

As metal is used for making many parts and components, metal parts with complex shapes are widely used in aerospace, shipbuilding, automotive, machine, electronics, and pharmaceutical fields. 3D printing can create complex parts that traditional methods cannot process. The use of 3D metal printing technology can greatly reduce the demand for spare parts, saving storage and related facilities and input costs. Large metal components include aircraft fuselage, aircraft engines, aviation equipment, railway cars, rails, hulls, ocean-going masts, trucks, cars, nuclear reactor control rods, oil casing, electro-hydraulic turbines, etc. Small metal components include automotive engines, gears, bicycle parts, watches, cookers, packaging components, electronic equipment, metal shell, etc.

The use of 3D printing technique to form metal components is an important development direction of the additive manufacturing. There is a variety of printing processes to achieve the indirect forming (Indirect Metal Forming, IMF) or direct forming (Direct Metal Forming, DMF) of the metal components. Metal indirect printing is to print the green parts of the forming parts first, and then the green parts are sintered into metal parts. Metal direct printing is to print as the metal components (Deych and Abenaim, US20150115494. Bai et Al., US20150069649. Uetani and Stuber, US20150125334).

In the indirect metal forming process, an organic binder is required, and the ablation of the binder results in a residue. For example, the ablation of sugar will produce coke, usually a certain kind of carbon particles. This residue will obviously form a contaminated product.

In the direct metal forming process, the heat source of the molten metal may be a laser beam, an electron beam, a plasma arc, or an electric heater. The position where the heat source interacts with the metal material may be on the metal powder layer preliminarily laid on the substrate, or in the molten bath on the substrate generated by the laser beam or the electron beam, or in the heating crucible other than the substrate (Wang Yun Gang et Al, “3D Printing Technology”, Huazhong University of Science and Technology Press, China; Wang Yun Gang et Al, “Three-Dimensional Print Free Molding”, Machinery Industry Press, China).

In the direct metal printing process, the laser beam welding sintering process is expensive due to the use of laser. The electron beam sintering process is also expensive (requires a very high vacuum environment), and has very power consumption. The size and the shape of the object will be limited due to the cavity space. The plasma arc process provides a relatively high deposition rate, but the molding accuracy is low and the resolution is low because it is difficult to control the metal wire to feed it into the small liquid pool of the made object.

The 3D metal printing is technically more challenging than the 3D printing of other materials due to the high temperature during the metal forming process and the tendency of the metal oxidation to occur as the temperature rises in the air. In general, the oxide on the surface of the metal particles hinders the welding or joining of the metal particles because the oxide (e.g., aluminum oxide, Al₂O₃) has a higher melting temperature point than the corresponding metal (e.g., aluminum, Al) has. Therefore, when the metal melts, the oxide does not melt. In addition, the metal powder per unit mass is more expensive than metal ingots. The fine particles of the metal powder are also more expensive than the large particles of the metal powder.

In order to make the particles melt and sinter completely, and the final 3D structure to obtain sufficient spatial resolution, the laser sintering, the electron beam sintering, and the powder metallurgy molding process require small enough metal particles. In addition, the surface area of the metal powder is larger than that of the metal ingot with same mass, and the metal oxidation on the surface is more serious than that of the metal ingot. This serious oxidation may cause dangerous combustion.

Compared to the metal ingots with same mass, metal wire is very expensive in metal arc welding process. The surface area of the metal wire is larger than that of the metal ingot with same mass. The smaller the diameter of the metal wire, the greater the surface area per unit mass. A sufficiently fine metal wire can completely melt the cross-section of the metal wire and give the final 3D structure a sufficient spatial resolution. As a result, the oxidation occurring on the surface of the metal wire is more severe than that on the metal ingot of the unit mass (Deborah Chung, Chinese patent application 201510593081.5).

Although the metal powder metallurgy process has a very high printing speed, it is very time-consuming because of the need for long time sintering. In addition, the metal powder is easier to oxidize and more expensive than that of the metal block. The sintering process is carried out in the fireplace, and thus the printed three-dimensional object is also limited in size. This sintering process usually takes a long time.

Electric heaters use resistance heating or electric furnace heating method. The crucible needs to be heated first, and then the metal in the crucible is heated through heat transfer. Thus the metal heating efficiency is low, the heating speed is slow, and the crucible temperature is very high. Therefore, this method is unsafe and will affect the environment.

Obviously, the traditional 3D metal printing methods such as laser beam, electron beam, plasma arc and so on cannot implement fast printing and cannot form large metal parts. They cannot be popularized because of the high prices. The electric heater method is inefficient, slow, and the temperature of crucible is very high, all of these affect the environment and are dangerous.

Therefore, there is a need for a new cost-effective 3D metal printing method that enables direct heating and rapid melting of metals, higher energy conversion efficiency, higher deposition rates, smaller oxide, higher safety and controllability, faster printing, and larger-size metal components manufacturing.

### SUMMARY OF THE INVENTION

In order to overcome the disadvantages of the existing 3D metal printing methods which cannot achieve rapid printing, cannot complete the molding of large metal components manufacturing, or the disadvantages which cannot be universally applied due to the expensive cost, or the disadvantages of low heating efficiency, slow heating speed and the crucible with very high temperature, this invention provides a new cost-effective 3D metal printing method that enables direct heating and rapid melting of metals, higher energy conversion efficiency, higher deposition rates, smaller oxide, higher safety and controllability, faster printing, and larger-size metal components manufacturing.

The invention adopts the following technical scheme for solving the technical problems above: the method of rapidly melting metal for 3D metal printers by electromagnetic induction comprises a nozzle, a crucible, a middle-high frequency inverter power supply, an electromagnetic induction coil, a cooling device and metal to be melted. The electromagnetic induction coil surrounds the crucible and the cooling device cools the electromagnetic induction coil. The middle-high frequency inverter power supply drives the electromagnetic induction coil by high current middle-high frequency (200 Hz to 2 MHz) sine wave or square wave signal, a high density magnetic field line is generated in the electromagnetic induction coil and produces a large eddy current in the metal in the crucible, so the metal in the crucible is rapidly melted due to such electromagnetic induction, and turns into fluid or liquid state. Then the fluid or liquid is ejected through the nozzle. The ejection methods can use some mature ways, such as piezoelectric, pneumatic, electric piston type (Wang Yun Gang et Al. “3D Printing Technology”, Huazhong University of Science and Technology Press, China), which will not be repeated here. Since this method is similar to that of ink-jet printing, it is inexpensive, and it can provide a high deposition rate and implement printing for large-size metal components. In addition, it can quickly melt metal (for instance, in a few seconds) with much higher thermal efficiency and less burning alloy elements. It has no environmental pollution and less oxide layer. The temperature and composition of the fluid or liquid of metal can be controlled accurately. Besides, the crucible can be made of not only non-electromagnetic induction material (such as corundum, etc.), but also electromagnetic induction material (such as graphite, steel, etc. In this case, a thermal insulation layer must be used between the crucible and electromagnetic induction coil for thermal isolation). Therefore, the external temperature of the entire rapid metal melting device is not high, so it is safe and reliable. In summary, this invention can implement cost-effective 3D metal printing, which carries out direct heating and rapid melting of metals with higher energy conversion efficiency, provides a higher deposition rate, smaller oxide, higher safety and controllability, prints faster, and implements larger-size metal components manufacturing.

The benefit of the present invention is that it achieves cost-effective 3D metal printing, which enables direct heating and rapid melting of metals, higher energy conversion efficiency, higher deposition rate, smaller oxide, higher safety and controllability, faster printing, larger-size metal components manufacturing.

### BRIEF DESCRIPTION OF THE DRAWINGS

FIG. 1 is an overall structure diagram of the present invention, which represents the method of the rapidly melting metal for 3D metal printers by electromagnetic induction.

FIG. 2 is a block diagram showing a basic circuit connection of an embodiment of the present invention.

FIG. 3 is a schematic of an embodiment of the present invention.

In the figures, R: nozzle, C: crucible, B: electromagnetic induction coil, P: middle-high frequency inverter power supply, D: cooling device, M: metal to be melted, L: fluid or liquid of metal, +V: operating voltage for middle-high frequency inverter power supply, C1: capacitor, L1&L2: inductors, Q1&Q2: field effect transistors, D1-D4: diodes, R1-R4: resistors.

### DETAILED DESCRIPTION OF THE EMBODIMENT

For a better understanding of the invention, an embodiment of the present invention will be described in detail hereinafter in conjunction with the drawings.

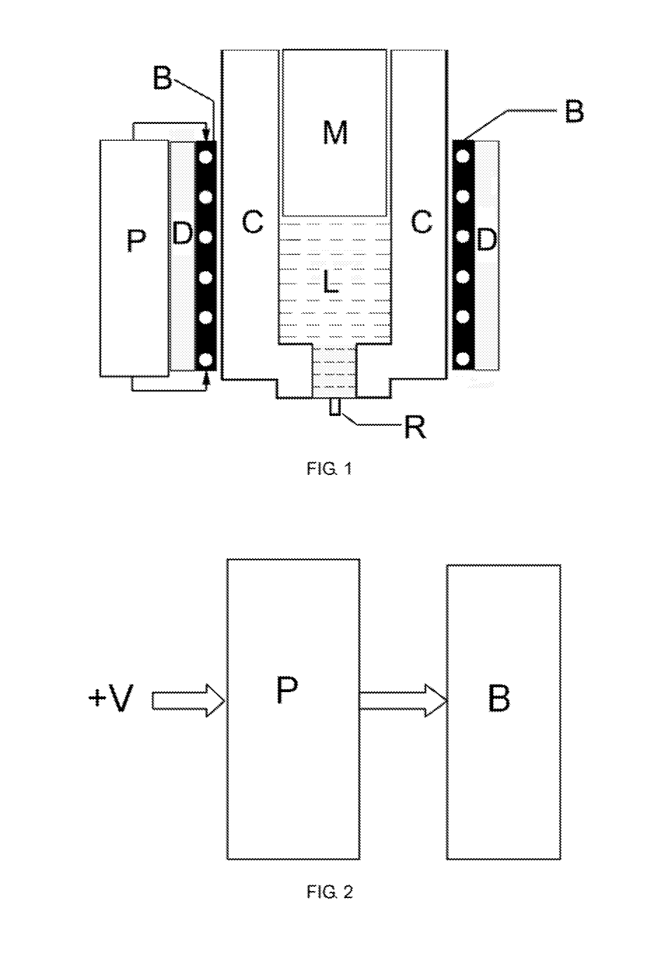

As shown in FIG. 1, the method of rapidly melting metal for 3D metal printers by electromagnetic induction comprises a nozzle (R), a crucible (C), a middle-high frequency inverter power supply (P), an electromagnetic induction coil (B), a cooling device (D), and metal to be melted (M). The electromagnetic induction coil (B) surrounds the crucible (C), and the cooling device (D) cools the electromagnetic induction coil (B). The middle-high frequency inverter power supply (P) drives the electromagnetic induction coil (B) by high current middle-high frequency (200 Hz to 2 MHz) sine wave or square wave signal, a high density magnetic field line is generated in the electromagnetic induction coil (B) and produces a large eddy current in the metal (M) in the crucible (C), so the metal (M) in the crucible (C) is rapidly melted due to such electromagnetic induction, and turns into the fluid or liquid of metal (L). The fluid or liquid of metal (L) is ejected through the nozzle (R). The ejection methods can be achieved in some mature ways, such as piezoelectric, pneumatic, electric piston type (Wang Yun Gang et Al. “3D Printing Technology”, Huazhong University of Science and Technology Press, China), which will not be repeated here.

FIG. 2 shows the block diagram of the basic circuit connection of the embodiment of the present invention: the middle-high frequency inverter power supply (P) is connected to the electromagnetic induction coil (B).

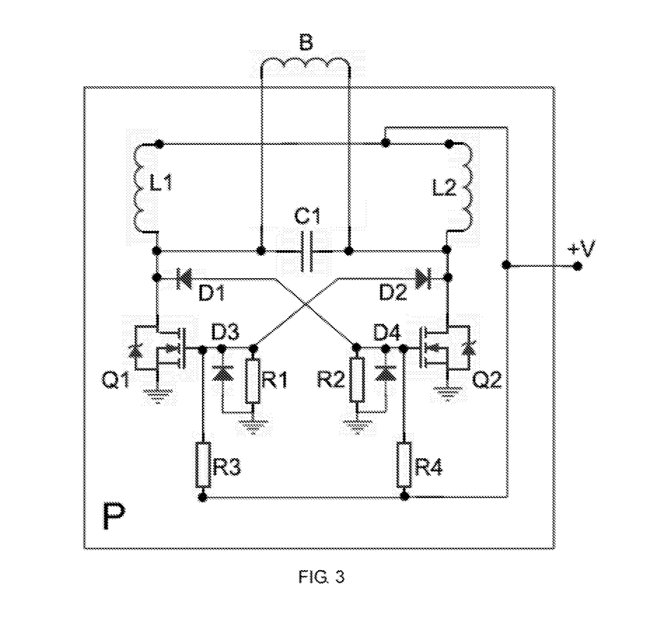

In the schematic of the embodiment shown in FIG. 3, two field effect transistors Q1, Q2 and its peripheral components (C1, B, L1, L2, D1-D4, R1-R4) make up a standard LC resonant selection frequency oscillation circuit, the resonant frequency f0=1/(2π\sqrt{BC1}), where the frequency range is from 200 Hz to 2 MHz. +V provides the power supply to the entire oscillation circuit, and B is not only the inductance of the LC resonant circuit, but also the electromagnetic induction coil. B is around the crucible (C), heats the metal (M) in the crucible (C) through electromagnetic induction, and then melts the metal (M) rapidly. The power output of the middle-high frequency inverter power supply (P) can be controlled easily by controlling the voltage of +V, so as to control the temperature and oxide rate of the fluid or liquid of metal (L) easily.

In summary, this invention can achieve cost-effective 3D metal printing which enables direct heating and rapid melting of metals, higher energy conversion efficiency, higher deposition rate, smaller oxide, higher safety and controllability, faster printing, and larger-size metal components manufacturing.

What is claimed is:

1. A method of rapidly melting metal for 3D metal printers by electromagnetic induction, comprising a nozzle (R), a crucible (C), a middle-high frequency inverter power supply (P), an electromagnetic induction coil (B), a cooling device (D) and metal to be melted (M), the electromagnetic induction coil (B) surrounds the crucible (C), the cooling device (D) cools the electromagnetic induction coil (B), the middle-high frequency inverter power supply (P) drives the electromagnetic induction coil (B) to rapidly melt the metal to be melted (M) in the crucible (C) due to electromagnetic induction to form fluid or liquid of metal (L), the fluid or liquid of metal (L) is ejected through the nozzle (R).

2. The method of rapidly melting metal for 3D metal printers by electromagnetic induction according to claim 1, wherein the output signal of the middle-high frequency inverter power supply (P) is a sine wave with frequency from 200 Hz to 2 MHz.

3. The method of rapidly melting metal for 3D metal printers by electromagnetic induction according to claim 1, wherein the output signal of the middle-high frequency inverter power supply (P) is a square wave with frequency from 200 Hz to 2 MHz.

4. The method of rapidly melting metal for 3D metal printers by electromagnetic induction according to claim 1, wherein the cooling device (D) is in a water-cooling manner.

5. The method of rapidly melting metal for 3D metal printers by electromagnetic induction according to claim 1, wherein the cooling device (D) is in an air-cooling manner.

6. The method of rapidly melting metal for 3D metal printers by electromagnetic induction according to claim 1, wherein the cooling device (D) is in a semiconductor cooling manner.

7. The method of rapidly melting metal for 3D metal printers by electromagnetic induction according to claim 1, wherein the electromagnetic induction coil (B) is made of a hollow metal pipe that is injected circulating water for cooling through the cooling device (D).

8. The method of rapidly melting metal for 3D metal printers by electromagnetic induction according to claim 1, wherein the crucible (C) is made of non-electromagnetic induction material.

9. The method of rapidly melting metal for 3D metal printers by electromagnetic induction according to claim 1, wherein the crucible (C) is made of electromagnetic induction material.

10. The method of rapidly melting metal for 3D metal printers by electromagnetic induction according to claim 1, wherein a thermal insulation layer is used between the crucible (C) and the electromagnetic induction coil (B) for thermal isolation when the crucible (C) is made of electromagnetic induction material.

11. The method of rapidly melting metal for 3D metal printers by electromagnetic induction according to claim 1, wherein a thermal insulation layer is used between the crucible (C) and the electromagnetic induction coil (B) for thermal isolation when the crucible (C) is made of non-electromagnetic induction material.
